(19) United States
(12) Patent Application Publication
(10) Pub. No.: US 2020/0196223 A1
(43) Pub. Date: Jun. 18, 2020

(54) METHOD, COMPUTER PROGRAM AND SYSTEM FOR PREDICTING THE AVAILABILITY OF A MOBILE PHONE NETWORK

(71) Applicant: ZF Friedrichshafen AG, Friedrichshafen (DE)

(72) Inventors: Mihai COANDA, Friedrichshafen (DE); Thomas SOMOZA, Stetten am Bodensee (DE)

(73) Assignee: ZF Friedrichshafen AG, Friedrichshafen (DE)

(21) Appl. No.: 16/712,537

(22) Filed: Dec. 12, 2019

(30) Foreign Application Priority Data
Dec. 18, 2018 (DE) 10 2018 222 077.8

(51) Int. Cl. H04W 48/14; G06F 17/18; H04W 24/10; G06N 20/00; H04W 4/02; H04B 17/318; H04W 76/11

(52) U.S. Cl. CPC H04W 48/14; G06F 17/18; H04W 24/10; H04W 76/11; H04W 4/025; H04B 17/318; G06N 20/00

(57) ABSTRACT

The present invention relates to a method for predicting the availability of a mobile telephone network, and a computer program and a system for this. In order to create a method that does not rely on existing network coverage maps or existing statistical data, the present invention proposes a method for predicting the availability of a mobile telephone network comprising the following steps: acquiring identification information from the mobile telephone network for at least one road user connected to the mobile telephone network; storing the information in a memory; sorting the stored information according to at least one sorting criterion; and using an algorithm to calculate a location and time dependent probability of the availability of the mobile telephone network based on the sorted information.

### RELATED APPLICATIONS

This application claims priority from German Patent Application DE 10 2018 222 077.8, filed Dec. 18, 2018, the entirety of which is hereby incorporated by reference herein.

### TECHNICAL FIELD

The present invention relates to a method and a control unit for operating an autonomous vehicle.

### BACKGROUND

A method for updating a digital map in a vehicle is known from DE 10 2017 009510 A1. Areas without network coverage are determined on the basis of a network coverage map from a mobile telephone network provider stored in the vehicle. A number of map data that are to be uploaded from a central memory via a mobile telephone network connection are variably activated at a vehicle position based on a network coverage and/or data transfer rate for this vehicle position stored in the network coverage map.

A method for dynamic uploading and providing media content in a vehicle is described in DE 2013 204373 A1, comprising the following steps: acquiring preferences of a user of the vehicle for media content; determining the media content available for uploading; and automatic uploading of media content corresponding to the user's preferences, taking into account: a current or predicted temporal and/or spatial availability and/or quality of a mobile telephone network, and/or a current and/or predicted vehicle position, and/or a current and/or predicted traffic situation, and/or a current and/or predicted state of the user, and/or the costs for transferring media content. In particular, the temporal and spatial availability and/or quality of a mobile telephone network is determined on the basis of statistical data regarding the network capacity of the mobile telephone network.

A disadvantage with the prior art described above is that it depends in both cases on existing network coverage maps or existing statistical data.

### SUMMARY

It is therefore the object of the present invention to create a method that does not rely on existing network coverage maps or existing statistical data.

To achieve this object, one aspect of the present invention proposes a method for predicting the availability of a mobile telephone network comprising the steps: acquiring identification information from the mobile telephone network for at least one road user connected to the mobile telephone network; storing the information in a memory; sorting the stored information according to at least one criterion; and using an algorithm to calculate a location and time dependent probability of the availability of the mobile telephone network based on the sorted information. The method according to the invention advantageously collects the information for calculating the location and time dependent probability of the availability of the mobile telephone network itself, such that reliance on existing and therefore potentially outdated network coverage maps or statistical data becomes obsolete.

In an advantageous development, the information is selected independently from an information pool comprising: the mobile telephone cell identification; time stamp; location of the road user; signal strength of the mobile telephone network; upload bandwidth; download bandwidth; meta-data; and mobile telephone network providers. The mobile telephone cell identification information, time stamp, location of the road user, signal strength of the mobile telephone network, upload bandwidth and download bandwidth are particularly suited in combination with one another for creating a capacity prediction map regarding the availability of the mobile telephone network.

In another design of the present invention, the road user is a motor vehicle or a pedestrian. Nearly all modern motor vehicles are normally equipped with communication units that are capable of transmitting information comprising the method according to the invention. Most pedestrians and bicyclists also carry a smartphone, which likewise forms a communication unit that is suitable for transmitting information comprising the method according to the invention.

The invention also provides that the memory can be a decentralized memory. A non-decentralized and therefore centralized memory is formed by a server, for example. A decentralized memory, e.g. an internet-based data cloud, is advantageous, because it is less likely to malfunction.

In another advantageous development of the present invention, the sorting criterion is formed from one or more criteria, selected from a pool of criteria comprising: the mobile telephone cell identification; time stamp; location of the road user; signal strength of the mobile telephone network; upload bandwidth; download bandwidth; meta-data; and mobile telephone network providers. These criteria, mobile telephone cell identification, time stamp, and location of the road user, are particularly suited in combination with one another for creating a map for the road user and third parties for predicting the location and time dependent availability of the mobile telephone network.

The algorithm can group the sorted information into defined time intervals. The information time stamp is used for this. The time intervals are preferably daytime segments, e.g. from 6:00 AM to 9:00 AM, 9:00 AM to 11:00 AM, 11:00 AM to 1:00 PM, 1:00 PM to 5:00 PM, 5:00 PM to 9:00 PM, and 9:00 PM to 6:00 AM on the next day. The present invention also comprises the option of shorter and longer time intervals, which can be implemented depending on the weekday.

In an advantageous development, the algorithm runs in an artificial neural network. An artificial neural network forming the fundamental network architecture offers major advantages through its learning capacity, which enables efficient pattern recognition, e.g. patterns relating to the location and time dependent availability of the mobile telephone network.

A second aspect of the present invention proposes a computer program for predicting the availability of a mobile telephone network, comprising computer programming means for executing the method according to the present invention when the computer program is executed on a computer.

A third aspect of the invention proposes a system for predicting the availability of a mobile telephone network, comprising means for executing the method according to the present invention.

The advantages of the method described above apply in their entirety to the computer program according to the invention and the system according to the invention, and are thus also advantages thereof.

### BRIEF DESCRIPTION OF THE DRAWINGS

The present invention shall be described on the basis of a preferred embodiment with reference to the drawing, wherein further advantageous details can be derived from the drawing. Therein:

FIG. 1 shows a schematic illustration of a method according to the present invention.

### DETAILED DESCRIPTION

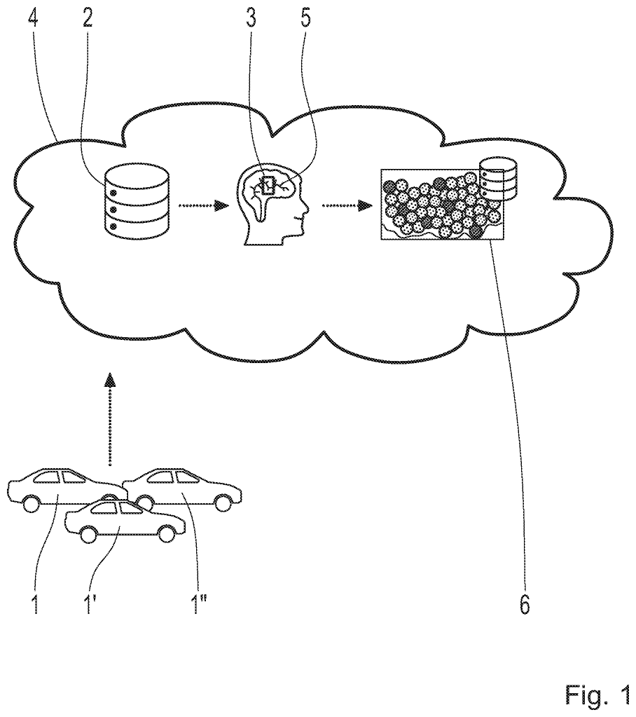

A schematic illustration of a method according to the present invention is shown in FIG. 1. The method is used for predicting the availability of a mobile telephone network and comprises the steps: acquiring identification information from the mobile telephone network for numerous, in this case three, road users 1, 1′, 1″ connected to the mobile telephone network; storing the information in a memory 2; sorting the stored information according to at least one sorting criterion; and using an algorithm 3 to calculate a location and time dependent probability of the availability of the mobile telephone network based on the sorted information. The acquired information comprises: the mobile telephone cell identification; time stamp; location of the road user 1, 1′, 1″; signal strength of the mobile telephone network; upload bandwidth; download bandwidth; meta-data; and mobile telephone network provider. The road users 1, 1′, 1″ are motor vehicles. Pedestrians or bicyclists equipped with smartphones can also be road users as set forth in the invention. The memory 2 is a decentralized memory 4 in the form of a data cloud in the internet. The acquired information is sorted based on time stamps. The information sorted according to the time stamps is grouped in defined time intervals as part of the algorithm 3, wherein the time intervals are segments of a day. The boundary between two adjacent time intervals is formed at times alternating between greater and lesser availability of the mobile telephone network. The algorithm 3 is run in an artificial neural network 5. The artificial neural network 5 is capable of learning and is therefore particularly suited to efficiently calculate the location and time dependent probability of the availability of the mobile telephone network. The calculated location and time dependent probability of the availability of the mobile telephone network is stored in a memory, and can be provided as a prediction map 6 for the location and time dependent availability of the mobile telephone network. These prediction maps 6 are significant, in particular for increasing safety in autonomous motor vehicles. By way of example, the method according to the invention enables the calculation of a download strategy along a planned vehicle route for downloading navigation map updates and other data from the internet when the probability of a high availability of the mobile telephone network is great, in order to be able to execute the download quickly and without errors.

An evaluation of the information according to the mobile telephone network provider enables the creation of a prediction map 6 for the location and time dependent availability of mobile telephone networks from different mobile telephone network providers, and selection of the mobile telephone network provider in each mobile telephone network cell based on the location and time that can provide the greatest bandwidth at that location. In the course of optimizing the location and time dependent availability of mobile telephone networks, it is advantageously possible to obtain the most efficient distribution of uploading and downloading data.

### REFERENCE SYMBOLS

1 road user

1′ road user

1″ road user

2 memory

3 algorithm

4 decentralized memory

5 artificial neural network

6 prediction map

1. A method for predicting availability of a mobile telephone network, the method comprising:
acquiring, by a computing device, information from the mobile telephone network about the mobile telephone network for at least one mobile device connected to the mobile telephone network;
storing, by the computing device, the information in a memory;
sorting, by the computing device, the stored information according to at least one sorting criterion; and
calculating, by the computing device, a location and time dependent probability of the availability of the mobile telephone network based on the sorted information.

2. The method according to claim 1, wherein the information comprises at least one of a mobile telephone cell identification, a time stamp, a location of the mobile device, a signal strength of the mobile telephone network, an upload bandwidth, a download bandwidth, meta-data, and a mobile telephone network provider.

3. The method according to claim 1, wherein the mobile device comprises at least one of a motor vehicle or a mobile telephone.

4. The method according to claim 1, wherein the memory is a decentralized memory.

5. The method according to claim 1, wherein the sorting criterion comprises sorting the information about the mobile telephone network by at least one of a mobile telephone cell identification, a time stamp, a location of the mobile device, a signal strength of the mobile telephone network, an upload bandwidth, a download bandwidth, meta-data, and a mobile telephone network provider.

6. The method according to claim 1, wherein calculating the location and time dependent probability of the availability of the mobile telephone network further comprises grouping the sorted information in defined time intervals.

7. The method according to claim 6, wherein the time intervals are segments of a day.

8. The method according to claim 1, wherein calculating the location and time dependent probability of the availability of the mobile telephone network further comprises executing, by the computing device, an artificial neural network to calculate the location and time dependent probability of the availability of the mobile telephone network.

9. A memory device, having stored thereon a computer program that, when executed on a computer, cause the computer to perform a method comprising:
acquiring, by the computer, information from a mobile telephone network about the mobile telephone network for at least one mobile device connected to the mobile telephone network;
storing, by the computer, the information in the memory;
sorting, by the computer, the stored information according to at least one sorting criterion; and
calculating, by the computer, a location and time dependent probability of an availability of the mobile telephone network based on the sorted information.

10. A system for predicting the availability of a mobile telephone network, comprising
a computing device coupled to a memory, the computing device configured to:
acquire information from the mobile telephone network about the mobile telephone network for at least one mobile device connected to the mobile telephone network;
store the information in the memory;
sort the stored information according to at least one sorting criterion; and
calculate a location and time dependent probability of the availability of the mobile telephone network based on the sorted information.

11. The system of claim 10, wherein the information about the mobile telephone network comprises at least one of a mobile telephone cell identification, a time stamp, a location of the mobile device, a signal strength of the mobile telephone network, an upload bandwidth, a download bandwidth, meta-data, and a mobile telephone network provider.

12. The system of claim 10, wherein the computing device is further configured to sort the information about the mobile telephone network by at least one of a mobile telephone cell identification, a time stamp, a location of the mobile device, a signal strength of the mobile telephone network, an upload bandwidth, a download bandwidth, meta-data, and a mobile telephone network provider.

13. The system of claim 10, wherein the computing device is further configured to calculate the location and time dependent probability of the availability of the mobile telephone network by grouping the sorted information in defined time intervals.

14. The system of claim 10, wherein the computing device is further configured to calculate the location and time dependent probability of the availability of the mobile telephone network by executing an artificial neural network to calculate the location and time dependent probability of the availability of the mobile telephone network.

15. The memory device of claim 9, wherein the information about the mobile telephone network comprises at least one of a mobile telephone cell identification, a time stamp, a location of the mobile device, a signal strength of the mobile telephone network, an upload bandwidth, a download bandwidth, meta-data, and a mobile telephone network provider.

16. The memory device of claim 9, wherein the computer program, when executed by the computer, causes the computer to perform the method further comprising:
sorting, by the computer, the information about the mobile telephone network by at least one of a mobile telephone cell identification, a time stamp, a location of the mobile device, a signal strength of the mobile telephone network, an upload bandwidth, a download bandwidth, meta-data, and a mobile telephone network provider.

17. The memory device of claim 9, wherein the computer program, when executed by the computer, causes the computer to perform the method further comprising:
calculating the location and time dependent probability of the availability of the mobile telephone network by grouping the sorted information in defined time intervals.

18. The memory device of claim 9, wherein the computer program, when executed by the computer, causes the computer to perform the method further comprising:
executing an artificial neural network to calculate the location and time dependent probability of the availability of the mobile telephone network.
